(19) United States
(12) Patent Application Publication
(10) Pub. No.: US 2021/0174432 A1
(43) Pub. Date: Jun. 10, 2021

(54) COMPUTER IMPLEMENTED METHOD AND SYSTEM FOR UPDATING A DATABASE SYSTEM FOR A BLOCKCHAIN VERSION CONTROL SYSTEM; COMPUTER IMPLEMENTED METHODS OF AUCTIONING AN ITEM FOR A SELLER, AND COMPUTER IMPLEMENTED METHOD OF UPDATING A SMART CONTRACT

(71) Applicant: PERPETUAL ALTRUISM LIMITED, London (GB)

(72) Inventors: Guillaume GONNAUD, London (GB); Edouard BESSIRE, London (GB); Hugo MCDONAUGH, London (GB)

(21) Appl. No.: 15/734,382

(22) PCT Filed: Aug. 2, 2019
(86) PCT No.: PCT/GB2019/052174

§ 371 Date: Dec. 2, 2020

(30) Foreign Application Priority Data
Aug. 7, 2018 (GB) 1812796.9
Jul. 17, 2019 (GB) 1910210.2

(51) Int. Cl. G06Q 30/08; G06F 16/23; G06Q 20/40; H04L 9/32; G06Q 20/02

(52) U.S. Cl. CPC G06Q 30/08; G06F 16/2379; G06Q 20/401; G06Q 2220/00; G06Q 20/02; H04L 2209/38; H04L 2209/56; H04L 9/3239

(57) ABSTRACT

A computer implemented method of updating a database system for a blockchain version control system, including a smart contract version control system, wherein proxied smart contracts each refer to a single centralized version controller smart contract which contains an index of smart contract logic code addresses, the method including the steps of: (i) updating a smart contract logic code addresses in an index so as to update the proxied smart contracts, and (ii) updating the database system for the blockchain version control system, to reflect the updating of the smart contract logic code addresses. There is further disclosed a computer implemented method of auctioning an item for a seller.

### BACKGROUND OF THE INVENTION

### 1. Field of the Invention

The field of the invention relates to computer-implemented methods of updating a database system for a blockchain version control system, and to related systems, to computer-implemented methods of auctioning an item for a seller, to computer-implemented methods of auctioning a digital item for a seller, wherein the digital item was previously purchased by the seller in a computer implemented method of auctioning the digital item, to computer implemented methods of providing a digital item for an auction, and to computer implemented methods of updating a smart contract. Related systems and computer program products are included.

### 2. Technical Background

Crypto collectibles have recently emerged as a compelling use of the blockchain. But challenges remain in respect of how to update smart contracts associated with the blockchain, how to auction crypto collectibles in an efficient way, how to provide for auction of crypto collectibles after they have already been purchased, how to bring crypto collectibles to auction, if it appears their current owner is no longer interested in maintaining their ownership or not able to maintain their ownership or not able to bring the crypto collectible to auction themselves, and how to modify the code in the associated smart contract, if it appears the crypto collectible publisher is no longer interested in maintaining the present code in the smart contract, or if it appears the crypto collectible publisher is not able to maintain the present code in the smart contract.

### 3. Discussion of Related Art

In US2018260212A1, entitled “Blockchain Version Control Systems”, distributed version control systems, methods, and computer-readable media are described. A computer system may implement a version control blockchain system by obtaining source code and/or an artifact associated with source code. The computer system may serialize the source code and/or the artifact to obtain serialized data, and may encipher the serialized data to obtain a current block identifier (cb_id). The computer system may generate a block to include the cb_id, and may add the generated block to the version control blockchain upon validation of the block.

EP3257191(B1) relates to the fields of tokenisation, blockchain and smart contract technologies. It provides a technical arrangement which simplifies the automated management of contracts, comprising a method and system which use a computer-based repository for storage of the contract. The contract is then represented by a transaction on the blockchain.

### SUMMARY OF THE INVENTION

According to a first aspect of the invention, there is provided a computer implemented method of updating a database system for a blockchain version control system, the blockchain version control system including a smart contract version control system, wherein a plurality of proxied smart contracts each refers to a single centralized version controller smart contract which contains an index of smart contract logic code addresses, the method including the steps of:

(i) updating the smart contract logic code addresses in the index of smart contract logic code addresses in the single centralized version controller smart contract, so as to update the plurality of proxied smart contracts, and
(ii) updating the database system for the blockchain version control system, to reflect the updating of the smart contract logic code addresses in the index of smart contract logic code addresses in the single centralized version controller smart contract, performed in step (i).

An advantage is that amendments to the smart contract can be made, using amendments to proxied smart contracts. An advantage is that this approach can be directly applied to instanced smart contract through a factory pattern. An advantage is that publishers just have to update the addresses in this version controller to update all of the instanced smart contracts at once.

The method may be one in which the blockchain is an Ethereum blockchain.

The method may be one in which a smart contract includes a smart contract address, a smart contract bytecode and a smart contract non-transitory memory state.

The method may be one in which to interact with a smart contract, the smart contract address is requested to execute the smart contract bytecode matching a function signature.

The method may be one in which the smart contract memory state is only ever accessed by the smart contract itself.

The method may be one wherein a basic smart contract interaction includes calling a Smart contract address, together with providing a function signature, and arguments.

The method may be one in which a virtual computer associated with the blockchain looks at the Smart contract address for any matching function signature code.

The method may be one in which if no matching function signature code is found then a fallback function is called instead.

The method may be one in which the fallback function makes a call to a different smart contract address, together with a function signature and arguments, wherein the call makes the different smart contract access the smart contract memory space instead of the different smart contract's memory space, and wherein the call returns values.

The method may be one in which the fallback function makes a call to a version controller which returns a returned address to be called, and a version index, wherein the returned address is called, together with a function signature and arguments.

The method may be one in which the fallback function makes a call to a version controller which returns a returned address to be called, wherein the returned address is called, together with a function signature and arguments.

The method may be one in which the call to the returned address makes a different smart contract access the smart contract memory space instead of the different smart contract's memory space, and wherein the call returns values.

The method may be one in which if matching function signature code is found then the arguments are loaded into memory and a bytecode found for the matching function signature is executed.

The method may be one in which the bytecode is the only bytecode authorized to modify any memory space associated with the smart contract address.

The method may be one in which a first smart contract can call another smart contract as part of the execution of one of the first smart contract's functions.

The method may be one in which when a first smart contract calls another smart contract, the other smart contract cannot access nor modify the memory space of the first smart contract.

The method may be one in which a smart contract bytecode is limited in size to a block size of the blockchain.

The method may be one in which any smart contract bigger than the block size of the blockchain is technically impossible to publish on the blockchain.

The method may be one in which a call is provided which makes the called smart contract access the first smart contract memory space instead of the called smart contract's memory space.

The method may be one in which a call is provided which makes the called smart contract execute the code of a remote smart contract in the called smart contract's memory context instead of executing the code in the remote smart contract memory space.

The method may be one in which the storage slots of the called smart contract and of the first smart contract must align, such that in each smart contract the same variable types must be declared, in the same order.

The method may be one in which if the updating process requires an initialization step, an intermediary update smart contract can be used, by inserting the new version of the business logic code in the Version Controller Storage Array, and setting the address at the previous Version Index to be the intermediary update smart contract address.

According to a second aspect of the invention, there is provided a user system for a blockchain version control system, the blockchain version control system including a smart contract version control system, the user system including a processor system and a database system, wherein

(i) the user system is configured to receive updated smart contract logic code addresses in an index of smart contract logic code addresses in a single centralized version controller smart contract, so as to update a plurality of proxied smart contracts, wherein the plurality of proxied smart contracts each refers to the single centralized version controller smart contract which contains the index of smart contract logic code addresses;
(ii) the processor system is configured to update the database system for the blockchain version control system, to reflect the updating of the smart contract logic code addresses in the index of smart contract logic code addresses in the single centralized version controller smart contract.

The user system may be one configured to perform a method according to any aspect of the first aspect of the invention.

According to a third aspect of the invention, there is provided a computer implemented method of auctioning an item for a seller, the method including the steps of:

(i) a server providing a starting price of the item to a plurality of computer terminals in communication with the server, wherein the starting price is a standing bid;
(ii) the server receiving a bid from a terminal of the plurality of terminals;
(iii) the server converting the received bid into a standing bid only if the received bid exceeds the previous standing bid by a threshold;
(iv) if the standing bid has increased, the server providing the standing bid to the plurality of computer terminals;
(v) repeating steps (ii) to (iv) until a condition is satisfied;
(vi) receiving payment for the item in relation to a final standing bid;
(vii) distributing incentive payments in relation to each standing bid, except for the final standing bid, to parties respectively associated with each standing bid;
(viii) distributing payment to the seller, which is the payment received in step (vi), minus at least the sum of the incentive payments in step (vii).

An advantage is that incentive payments are distributed to bidders, which may lead to a more efficient auction process, for example in that the auction completes more quickly, or that the computer implemented method requires less energy, because the auction completes more quickly. Another advantage is that the method may lead to better price discovery for all kinds of one-of-a-kind assets, such as crypto collectibles or even a work of art e.g. by Picasso.

The method may be one wherein in step (vi) the server receives the payment for the item in relation to the final standing bid.

The method may be one wherein as soon as the standing bid has increased, a respective incentive payment is made. The payment may be made in the sense that the money is in the smart contract available for withdrawal by the relevant party unconditionally.

The method may be one wherein in step (vii) the server distributes the incentive payments in relation to each standing bid.

The method may be one wherein in step (viii) the server distributes the payment to the seller.

The method may be one wherein no incentive payment is distributed in relation to the starting price.

The method may be one wherein each incentive payment is a portion of an amount by which the respective standing bid exceeded the previous standing bid.

The method may be one wherein the portion is a fixed fraction, less than one.

The method may be one wherein the condition in step (v) is that a time limit for the total time for the auction is reached.

The method may be one wherein the condition in step (v) is that a time limit for no new standing bid occurring is reached.

The method may be one wherein the threshold in step (iii) is a fraction less than one, of the current standing bid.

The method may be one wherein the item is a digital item.

The method may be one wherein the server transmits the digital item to a party associated with the final standing bid.

The method may be one wherein the server records in a blockchain a transaction in which the item was sold by the seller to a party associated with the final standing bid.

The method may be one wherein the server records the transaction in the blockchain as a smart contract.

The method may be one wherein the server records in a blockchain each new standing bid.

The method may be one wherein the server records each new standing bid in the blockchain as a smart contract.

The method may be one wherein the blockchain is an Ethereum blockchain.

The method may be one wherein the method is implemented in a closed computer ecosystem.

The method may be one wherein each new submitted bid is required to include a reference to the value of the current standing bid at the moment the new bid is submitted.

The method may be one wherein the payments are cryptocurrency payments.

The method may be one wherein all bids are fully funded.

According to a fourth aspect of the invention, there is provided a computer implemented method of auctioning a digital item for a seller, wherein the digital item was previously purchased by the seller in a computer implemented method of auctioning the digital item, this method including the steps of:

(i) a server receiving a bid for the digital item from a terminal of a plurality of computer terminals in communication with the server, wherein the server uses the bid as the standing bid;
(ii) the server providing the standing bid to the plurality of computer terminals;
(iii) the server receiving a bid from a terminal of the plurality of terminals;
(iv) the server converting the received bid into the standing bid only if the received bid exceeds the previous standing bid by a threshold;
(v) if the standing bid has increased, distributing an incentive payment in relation to the previous standing bid;
(vi) if the standing bid has increased, the server providing the standing bid to the plurality of computer terminals;
(vii) repeating steps (iii) to (vi) until a command is received from the seller to terminate the auction.

An advantage is that incentive payments are distributed to bidders, which may lead to a more efficient auction process, for example in that the auction completes more quickly, or that the computer implemented method requires less energy, because the auction completes more quickly. Other advantages include better price discovery (as in an auction), instant liquidity (as the seller may terminate this perpetual auction at any time), and preventing black market deals (as the seller can only ever accept the current standing bid).

The method may be one wherein any respective bid may be retracted using a respective terminal of the plurality of terminals at any time before the command is received from the seller to terminate the auction.

The method may be one wherein if the current standing bid is withdrawn, a penalty payment must be received.

The method may be one wherein if the standing bid has increased, a payment must be received from the bidder for the new standing bid, to provide payment for the incentive payment to the bidder for the previous standing bid.

The method may be one wherein if the current standing bid is withdrawn, there is no refund of the incentive payment that was made to the bidder of the previous standing bid.

The method may be one wherein after the command is received from the seller to terminate the auction, the digital item is sold from the seller to the holder of the highest standing bid, and a new auction according to the fourth aspect of the invention starts, with the previous standing bid becoming the current standing bid.

The method may be one wherein after the command is received from the seller to terminate the auction, the digital item is sold from the seller to the holder of the highest standing bid, and the publisher of the digital item receives a commission payment.

The method may be one wherein if the standing bid has increased, the publisher of the digital item receives a commission payment.

The method may be one wherein all bids are fully funded.

The method may be one wherein in step (v) if the standing bid has increased, funding for the bid is received (e.g. by the server).

The method may be one wherein after step (viii) the payment is distributed to the seller (e.g. by the server).

The method may be one wherein each incentive payment is a portion of an amount by which the respective standing bid exceeded the previous standing bid.

The method may be one wherein the portion is a fixed fraction, less than one.

The method may be one wherein the threshold in step (iv) is a fraction less than one, of the current standing bid.

The method may be one wherein the server transmits the digital item to a party associated with the final standing bid.

The method may be one wherein the seller can set an asking price that, if met, terminates the auction.

The method may be one wherein the server records in a blockchain a transaction in which the item was sold by the seller to a party associated with the final standing bid.

The method may be one wherein the server records each transaction in the blockchain as a smart contract.

The method may be one wherein the server records in a blockchain each standing bid.

The method may be one wherein the server records each standing bid in the blockchain as a smart contract.

The method may be one wherein the blockchain is an Ethereum blockchain.

The method may be one wherein the method is implemented in a closed computer ecosystem.

The method may be one wherein each new submitted bid is required to include a reference to the value of the current standing bid at the moment the new bid is submitted.

The method may be one wherein the payments are cryptocurrency payments.

According to a fifth aspect of the invention, there is provided a computer implemented method of providing a digital item for an auction, the method including the steps of:

(i) a server accessing a record associated with a smart contract in a blockchain with respect to the digital item, the record recording the owner of the digital item, to determine the time of the most recent interaction of the owner with the smart contract regarding the digital item;
(ii) the server initiating a first timer which times the time since the most recent interaction of the owner with the smart contract regarding the digital item;
(iii) the server running the first timer;
(iv) the server resetting the first timer to zero if a communication is received from the owner recorded in the record;
(v) repeating steps (iii) to (iv), until a time limit of the first timer is reached;
(vi) after the time limit of the first timer is reached, receiving a first specific call at the server in respect of the digital item;
(vii) the server initiating a second timer which times the time since the first specific call was received;
(viii) the server running the second timer;
(ix) the server resetting the first timer to zero and returning to step (iii) if a communication is received from the owner recorded in the record;
(x) repeating steps (viii) to (ix), until a time limit in relation to the first specific call is reached;
(xi) after the time limit in relation to the first specific call is reached, releasing the digital item for auction using a computer implemented method.

An advantage is that if a user is no longer able to sell the digital item (for example if a user permanently loses access to the digital wallet holding the item and thus cannot auction it him/herself), the digital item is auctioned off. An advantage of the method is that if a user is no longer motivated to maintain ownership of a digital item (for example, if there is a maintenance fee to the digital item), the digital item is auctioned off. An advantage is that a digital item will not become lost, because it will eventually be made available for auction, e.g. if the owner has lost access to the digital item and thus cannot auction it him/herself, or if the owner has no further interest in the digital item.

The method may be one including a step between steps (x) and (xi) of receiving a second specific call at the server in respect of the digital item.

The method may be one wherein the computer implemented method of step (xi) is a computer implemented method of any aspect of the third or fourth aspects of the invention.

The method may be one in which a previous highest bid is used as a starting bid.

The method may be one wherein the timer in step (ii) is reset every time the digital item is sold.

The method may be one wherein the digital item includes a token.

The method may be one wherein after step (vi), the server sends a communication to the owner recorded in the record to notify them that the first specific call has been received.

According to a sixth aspect of the invention, there is provided a computer implemented method of updating a first smart contract, the method including the steps of:

(i) a server accessing a record associated with the first smart contract in a blockchain, the record recording a publisher in relation to the first smart contract, to determine the time of the most recent interaction of the publisher regarding the first smart contract, and the blockchain further including other smart contracts and records of owners of the other smart contracts, accessible by the server;
(ii) the server initiating a timer which times the time since the most recent interaction of the publisher regarding the first smart contract;
(iii) the server running the timer;
(iv) the server resetting the timer to zero if a communication is received from the publisher recorded in the record;
(v) repeating steps (iii) to (iv), until a time limit of the timer is reached;
(vi) after the time limit of the timer is reached, receiving a specific call at the server in respect of the first smart contract, from an owner of another smart contract, recorded on the blockchain, and the server verifying that the specific call received at the server in respect of the smart contract is from an owner of another smart contract, recorded on the blockchain;
(vii) the server receiving proposed code to update the first smart contract from the owner of the other smart contract;
(viii) the server communicating the proposed code to update the first smart contract, to the other smart contract owners recorded on the blockchain, and offering a vote to the other smart contract owners on whether to accept the proposed code to update the first smart contract;
(ix) the server receiving votes from the other smart contract owners recorded on the blockchain, within a time limit;
(x) the server updating the first smart contract with the proposed code, if a majority of the votes received within the time limit approve accepting the proposed code to update the first smart contract.

An advantage is that a smart contract can be updated with code proposed by an owner of another smart contract recorded in the blockchain, if the existing publisher is no longer showing interest in maintaining the existing smart contract code or if the publisher has lost access to the smart contract and thus cannot propose code to update the smart contract.

The method may be one wherein the owners of the other smart contracts are users who are the owners of respective digital items whose respective record is associated with a respective smart contract.

The method may be one wherein the timer is implemented using blockchain software executing on the server.

The method may be one wherein the timer which times the time since the most recent interaction of the publisher regarding the first smart contract, measures time based on a number of blocks processed by the blockchain software.

The method may be one wherein the blockchain is an Ethereum blockchain.

The method may be one wherein the proposed code rewrites the way money flows or how the first smart contract behaves.

The method may be one wherein each owner can set a new addresses for their smart contract's beneficiaries.

The method may be one wherein the smart contract is in relation to a digital item that has been auctioned according to a method of a computer implemented method of any aspect of the third or fourth aspects of the invention.

Aspects of the invention may be combined. Related systems and computer program products may be provided.

### BRIEF DESCRIPTION OF THE FIGURES

Aspects of the invention will now be described, by way of example(s), with reference to the following Figures, in which:

FIG. 1 shows an example of a Cryptograph ecosystem.

FIG. 2 shows an example of bids in a GBM auction.

FIG. 3 shows: in the example on the left hand side of FIG. 3, the new bid has a small bid increase, which implies a small bid incentive percentage; in the example on the right hand side of FIG. 3, the new bid has a large bid increase, which implies a large bid incentive percentage.

FIG. 4 shows an example in which the maximum number of incentives have been paid out, and the upper bound percentage is equal to the proportion of the minimum incentive relative to the minimal step.

FIG. 5 shows examples of bids in a GBM perpetual bidding system.

FIG. 6 shows an example of a stateless marketplace.

### DETAILED DESCRIPTION

### Introduction

Collectibles, which are items valued and sought after by collectors in part because of their scarcity, have been known for thousands of years. Items created purposefully to be collectibles by companies, such as trading cards or memorabilia, however, are much more recent. The business of manufacturing or publishing collectibles and their respective business models did not change much until the advent of digital collectibles in the 1990s. The digital age enabled closed software environments where publishers could control the ownership, the scarcity and the second hand market of their collectibles to a much greater extent. However, they also had a trade-off between scarcity and ownership, as the publishers had complete control over their creation. Blockchain (a decentralised ledger) technology and smart contracts introduced the tools to solve the issues, whilst preserving most of the benefits of physical and digital collectibles. Hence blockchain-powered digital collectibles a.k.a. crypto collectibles have recently emerged as a compelling use of the blockchain, with some success stories in 2017. In this document, we first discuss the evolution of collectibles and their limitations in the digital age, how blockchain technology redefines ownership, how smart contracts build trust and how non-fungible tokens have paved the way for a new breed of digital collectibles. We then introduce Cryptograph, a new blockchain-based digital collectible created by famous individuals to raise money for charitable causes in perpetuity. We lay out Cryptograph's sustainable economic model, the features allowing its perpetuity, the governance and the ability for the community to create their own collectibles using the Cryptograph smart contract. We study the pricing mechanisms used currently for the sale of collectibles and we propose our own incentivised pricing systems: the Gonnaud-Bessire-McDonaugh (GBM) auction and the GBM perpetual bidding system. Finally, we present the technical choices behind the Cryptograph ecosystem, before concluding.

### I. DIGITAL COLLECTIBLES, OWNERSHIP AND SCARCITY

### 1. Manufactured and Digital Collectibles

The urge to collect unusual and fascinating objects is primeval. Collectibles, which are items valued and sought after by collectors in part because of their scarcity, have been around for over a thousand years. In the 19th century, manufactured collectibles i.e. items made specifically for people to collect, began to appear. Manufactured collectibles have been used in one of two different ways by the companies that manufacture them. Either the manufactured collectible is sold alongside a product/service (e.g. McDonald's Happy Meal toys) to make the product/service more attractive to customers, or the manufactured collectible is sold for its own collectible value (e.g. signed memorabilia) or utility value (e.g. trading card games such as Magic The Gathering).

Manufactured collectibles sold for their own collectible and utility value may have an important limitation: the company manufacturing the collectible may make all of its revenue on the primary sale of the item because it may have no control beyond that first transaction. The consequence is that the manufacturer may not be incentivised to maintain or increase the value of the collectible past the initial sale, so the company's business model does not align with the interest of collectors. Trading card games are a great example of how a collectible manufacturer maximises revenue with this limitation. A first set of cards is released and sold in randomized “booster packs” with artificial scarcity created for the most powerful cards. This forces collectors to buy more of the collectibles in order to get the cards with the highest collectible and utility value. Once the initial sales start to weaken, the trading card game company releases a new set of slightly more valuable cards. This new set will gradually phase out the previous set, which will drive the value of existing cards down, and push collectors to buy the new set of booster packs. Although manufactured collectible companies have found ways to generate revenue from continued original sales, they have not been able to tap into the big missed opportunity that the secondary market represents. Rare and sought after manufactured collectibles are regularly sold by independent sellers for a hundred or even a thousand times what their original price was, and the company that manufactured that collectible has no way to benefit from the appreciation. This is where digital collectibles make their entrance.

The digital collectible appeared in the late 1990s, in the wake of the digital revolution. A digital collectible is one that, unlike a physical collectible, is not a physical object. It only exists virtually, as computer code. The first digital collectibles that came to be worth significant sums of money were scarce items that had utility value in multiplayer video games (e.g. a more powerful weapon or stronger armour). Because of their digital nature, digital collectibles removed some of the physical collectible limitations, but also introduced some of their own.

Notably, a digital collectible theoretically cannot be damaged or lost, and the transfer of its ownership can be done instantly and across borders. One drawback is that because any data that can be read by a computer can also be copied by that same computer, for a digital collectible to exist (and not be copied) the only viable way for a publisher (i.e. a company publishing a digital collectible) to create digital collectibles is to do so in a controlled software environment, where copying data can be restricted. Such controlled environments prevented counterfeit and theft, but also allowed for the first time companies to build a secondary market for their collectibles such as in-game auction houses where players could trade items and the publisher would charge a commission.

Taking control of the secondary market gave publishers new revenue opportunities. However, this control of secondary markets has always been far from absolute. In the $5 billion video game skin (cosmetic items) market, for example, developers are simply preventing trades or taking a cut on each trade, but still, second-hand markets have emerged undercutting the developers. The digital collectible has given the opportunity to tap into the secondary market, but not to eradicate black market deals.

Another serious limitation of closed software digital collectibles is the trade-off between a digital collectible's scarcity and its ownership. A digital collectible which resides in a controlled software environment means the publisher can control its scarcity. The trade-off is that any collector who wishes to acquire a digital collectible must agree to the Terms of Use of that collectible controlled software environment. This may give full rights to the publisher over the digital collectible, hence the collector may never be the true owner, unlike with a physical collectible. Furthermore, as the digital collectible only exists on the publisher's servers, the collectible will be in jeopardy the day the publisher thinks it is not economically viable to maintain the servers. Solving these digital collectible issues required three innovations: The blockchain, smart contracts and non-fungible tokens.

### 2. Blockchain and Property Rights

The notion of property is a pillar of society, and its evolution has always been correlated with deep societal changes. The value of a collectible is strongly linked to property rights: if something cannot be owned, bought or sold, it cannot have a collectible value. Similarly, a collectible which cannot be protected against destruction, counterfeit or theft, cannot have a sound value.

For most of our history, property rights have relied exclusively on the monopoly on violence. Before property rights, each individual used force to protect their property. Society emerged when individuals empowered a group of people (e.g. army, police) to exercise a monopoly on violence on their behalf. A monopoly on violence allowed for the establishment of a legal system which can be enforced, and the legal system defined property rights, which have evolved over the centuries. Until the end of the Middle Ages, the general lack of literacy and industrial production meant that the definition of property was simpler. With the advent of industrialised printing and the ability to copy the work of others with minimum effort, the first copyright laws were introduced. The digital age and especially the internet became a new challenge to property rights as copying someone else's work went from cheap to almost free. Furthermore, property rights can only be enforced in the geographic area of the monopoly on violence, which in a global and connected world has brought new challenges for governments and companies. New licencing frameworks (Creative Commons, GPL (General Public License)) and treaties (ACTA (Anti-Counterfeiting Trade Agreement), Access to Knowledge (A2K) movement) were created to answer these digital needs, and value shifted from content to service. Closed software environments allowed companies to enforce property rights themselves in an ecosystem where they could dictate the rules and gather data on users. Steam, Netflix and Spotify have pretty much killed piracy while compact disc (CD) resellers went out of business.

Starting with the publication of the Bitcoin white paper in 2008, a new form of ownership has been emerging over the last decade, one powered by blockchain technology. Blockchain technology defines property rights without a legal system or a monopoly on violence. Consensus on the software specifications for the blockchain have replaced the community of law and prevented the creation of counterfeit and theft, enforced with unsolvable mathematical problems. This is a fundamental shift in digital ownership. Blockchain technology also allows individuals to exchange digital goods following specific rules that are publicly readable and enforced by a decentralised authority, without the necessity or the possibility of a closed software environment. An entity that wishes to create tokens abiding to certain rules can either set-up their own blockchain, or publish software (smart contracts) to an existing blockchain. This means an individual or company can create and automate publishing and trading rules for specific tokens with no centralised authority. In such cases, blockchain and smart contract technology provide the tools to circumvent the limitations of digital collectibles by guaranteeing scarcity whilst letting the publisher create rules which ensure the continuing alignment of interest between the publishers and the collectors.

### 3. Non-Fungible Tokens and Scarcity

Blockchain technology paved the way for a new kind of digital collectible: the crypto collectible. Until 2017, applications of blockchain technology mainly used tokens as currencies, vouchers or as securities. For these applications, the true scarcity provided by the blockchain serves to produce a limited amount of fungible and divisible tokens that are means of exchange, units of account, or stores of value. However, for a digital collectible to exist on a blockchain, it must be non-fungible and indivisible.

Non-fungible tokens (NFT's) were first implemented in 2017, and rapidly established the concept of a crypto collectible. Non-fungible tokens are unique, stored individually and can be distinguished from each other, allowing them to individually have a collectible value. A crypto collectible is basically a digital collectible that resides on a blockchain, instead of in a closed system environment. Thanks to the blockchain, the ownership and scarcity of these tokens are verifiable without the need of a trusted party. Furthermore every transaction is public and token ownership is traceable from inception. These properties cannot be tampered with because of the decentralized nature of the blockchain, unlike a normal digital collectible where the publisher is the central authority. Another powerful implication is that anyone can build a software ecosystem utilizing a token. Even if the company that issued the token (e.g. a collectible publisher) disappears, the ownership and scarcity of the tokens are preserved, and applications that use them can be built and rebuilt. Therefore, the blockchain has the potential to give a crypto collectible perpetuity, something that even physical collectibles cannot offer.

One of the earliest crypto collectibles were CryptoPunks: unique collectible characters with proof of ownership stored on the Ethereum blockchain. Released in June 2017, each CryptoPunk character is its own non-fungible token, and by early 2018 some the most coveted CryptoPunks were selling for over $10,000. Following the success of CryptoPunks other crypto-collectibles were created. The most successful of these to date is Crypt® Kitties, launched in November 2017 by publisher Axiom Zen (now Dapper Labs Inc). Crypt® Kitties is a game where players can acquire, breed and trade creatures called Kitties. Each Kitty resides on the Ethereum blockchain as a non-fungible token and each one has a unique genome that defines its appearance and traits. Over 400,000 Kitties have now been sold to date for a combined value of over $25 million.

### II. CRYPTOGRAPH

### 1. The Cryptograph

A Cryptograph is a unique digital collectible created by e.g. a world famous individual or group. It can be anything as long as it is digital, such as a song, a video, an artwork, a piece of prose, a performance etc. Its purpose is to raise money for its creator and awareness for charitable causes in perpetuity, and optionally to raise money for a charitable cause of its creator's choice. Cryptographs are unique and cannot be copied or destroyed. Each one will exist forever. In essence, a Cryptograph is the digital legacy that its creator wants to leave behind to the world.

Each Cryptograph is made up of both the media that is created by the famous individual/group and the token that is minted alongside this media. The token is on the blockchain which ensures its perpetual existence and the immutability of its ownership. The media of the Cryptograph is publicly available, but in an example only one person can ever own the token at a time. Owning a Cryptograph also bestows upon the owner certain rights over the media allowing them to use, copy, distribute and display it in ways others cannot. Features Cryptograph owners have access to may include:
The right to vote on upgrades to the smart contract.
The right to use, copy, distribute and display the Cryptograph media.
The ability to add 3 characters to the “Makers Mark Array” in the token, e.g. your initials.
The ability to display Cryptographs within the official Cryptograph App.
The ability to display the unique digital badge that exists for each Cryptograph.

A Cryptograph starts its life as an idea. Perhaps a cause close to the Cryptograph creator's heart, or something special the creator wants to leave to the world. Once created, the Cryptograph is incorporated onto the blockchain and may be put to auction e.g. using our innovative price discovery system, the GBM Auction (see section III.2). The majority of the proceeds from the auction may go directly to the charitable cause. After auction, the Cryptograph can be traded between collectors on our marketplace forever, and each time it is transacted further money is raised for the charitable cause that the Cryptograph supports.

A Cryptograph is not only a legacy, it is a link between the creator and the collectors.

### 2. The Cryptograph Ecosystem

### The Cryptograph App

The Cryptograph App allows collectors to easily carry, browse and experience their entire Cryptograph collection. A Cryptograph App may be executed on a smartphone, on a tablet computer, on a desktop computer, or on a smart TV, for example.

Collectors log in to the Cryptograph app with their digital wallet address safely without the need to copy their private key. The first time collectors log in to the app, they may register their digital wallet address through a simple and fast login using a quick response (QR) code on our website on a dedicated page. This will allow the user to send a transaction to the blockchain from their digital wallet address publishing the unique ID of their installed app, which allows the app to know that you are indeed the genuine owner of the digital wallet.

Trading Cryptographs is currently not allowed on the Cryptograph App, because of Google Play Store (Android) and App Store (iOS) cryptocurrency rules. Although this may change in the future, collectors must at the moment visit our website in order to trade Cryptographs.

### The Cryptograph Website

The Cryptograph website is the marketplace where collectors can browse, buy and sell any Cryptograph in circulation, as well as participate in ongoing Cryptograph auctions. The Cryptograph website is hosted on a server, for example on a real server, or on a virtual server.

Collectors can log in to their digital wallet on our website using browser extensions or mobile apps such as MetaMask and Coinbase Wallet. Once connected, collectors can easily do everything that they need to in order to trade effectively and also manage their collection, such as placing bids during an auction and accepting bids from other collectors during trading on our secondary market. Collectors can also browse every Cryptograph in circulation on the website and already get a comprehensive overview of the real time market activity, without needing to be logged in.

Moreover, people with the app installed can check that every Cryptograph is genuine by scanning them using their smartphone camera. This prevents phishing, as only the Cryptographs displayed on our website would react to being scanned by our app.

### The Cryptograph Smart Contract

Cryptographs on the blockchain are all connected to a smart contract that hosts all the tokens and their details, such as their unique names. The Cryptograph smart contract sets out all of the parameters of what someone can and cannot do with a Cryptograph, and it executes all the actions that users can perform when they interact with a Cryptograph.

The smart contract is also responsible for implementing the GBM auctions and trading rules as well as the renatus and centimani protocols, as described later on in this document. The smart contract also contains the hashes of the original medias (ensuring they are all genuine) and links to the media hosted on a Peer-to-peer (P2P) network where we as the company pledge to always provide a seed. Such availability to the contract allows the community to build their own software if they should wish to, in order to show off their cryptographs.

### 3. Sustainable Philanthropic Model

The company behind Cryptograph is Perpetual Altruism Ltd, a London-based social enterprise. Our organisation, like any other social enterprise, applies commercial strategies to try and maximize social impact alongside creating value for its shareholders. Unlike a traditional charity which relies on donations to keep funding charitable initiatives, our sustainable business model allows us to operate and grow the value and number of Cryptographs in order to increasingly support our philanthropic activities without outside financial help.

Our innovative business model rewards everyone who takes part in our ecosystem. The Cryptograph's creator, the charities, the collectors and our company are all incentivised to make sure that each Cryptograph continues to make a positive impact in the world in perpetuity.

Each Cryptograph may generate revenue in the following ways:
1. When first sold at auction, between 80%-95% of the Cryptograph final selling price is generated as revenue (depending on the bidding patterns during the auction, see section 3.2)
2. When a buyer places a bid on a Cryptograph in secondary market trading, 0.5% of that bid is generated as revenue.
3. When a Cryptograph is sold on the secondary market, 10% of the selling price is received as revenue.

Between 50% and 75% of all revenue generated by each Cryptograph (described above) goes directly to the charity selected by that Cryptograph's creator. The charity's cut depends on the Cryptograph's creator, which can be anything between 0% (giving all 75% of revenues for the chosen charity) and 25% (giving 50% of all revenues for the charity). Our company keeps the remaining 25% to manage the tech infrastructure and to ensure the perpetuity of existing cryptographs, as well as to create new Cryptographs and further promote the Cryptograph ecosystem.

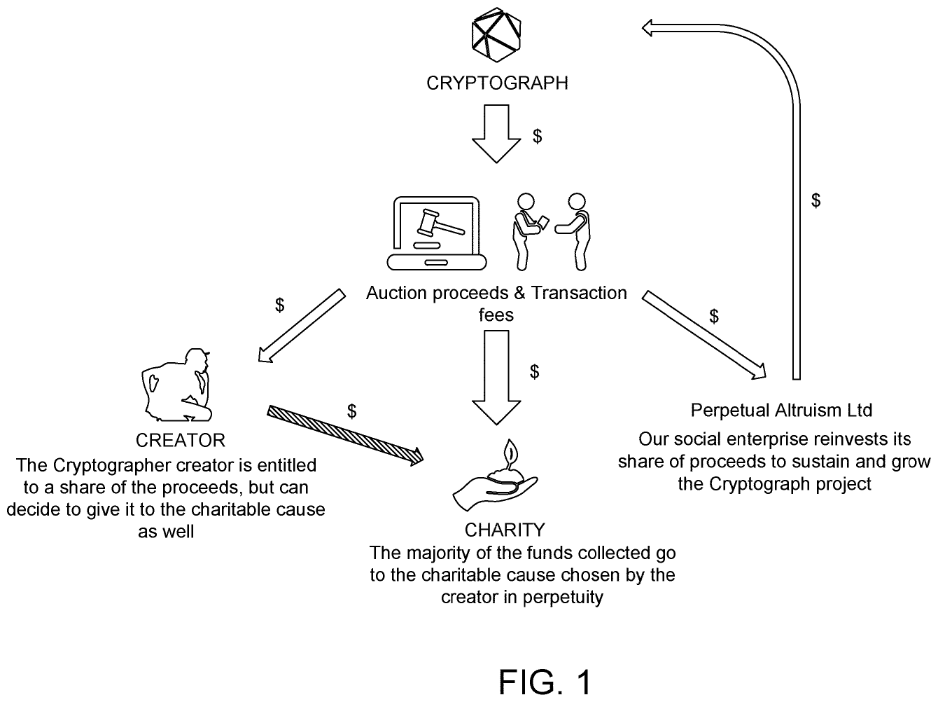

FIG. 1 shows an example of a Cryptograph ecosystem.

As Cryptographs are implemented on the Ethereum blockchain (see section II.5. Why The Ethereum Blockchain), all revenues collected by Perpetual Altruism Ltd are in Ether (ETH), the cryptocurrency of the Ethereum blockchain. Perpetual Altruism Ltd converts ETH into fiat currency and distributes them to the chosen charities, unless the charities wish to receive donations directly in Ether.

### 4. Perpetuity

In an example, the notion of perpetuity is of great importance for a Cryptograph. Making sure each Cryptograph exists and carries out its purpose in perpetuity means a Cryptograph is more than a collectible. It is a legacy, a piece of the essence and personality of an icon that lives on and gives to causes that its creator and descendants care about.

### A Cryptograph Cannot be Destroyed

The decentralised nature of the blockchain makes it nominally impossible for a Cryptograph to be destroyed.

A Cryptograph can Survive without Us

We have created Cryptograph so that even if our social enterprise Perpetual Altruism disappears for any reason, Cryptographs will live on forever in the hands of the community. If ever Perpetual Altruism were to disappear, each Cryptograph owner will become responsible for their Cryptograph and will receive Perpetual Altruism's share of the proceeds to maintain the Cryptograph ecosystem and continue carrying out its purpose. The distribution rights to each Cryptograph will be transferred to the current owner, and the license will keep being transferred with the token ownership as long as they fulfil the responsibilities of Perpetual Altruism for that Cryptograph. This mechanism makes us the first company that would become fully decentralized at its death, ensuring that the Cryptograph community has everything they need to continue the Cryptograph legacy.

### A Cryptograph Cannot be Lost

Cryptographs have a built-in recovery function. Although the blockchain guarantees a safe and decentralised registry of ownership, one potential issue with a token is when someone mistakenly or intentionally sends a token to a wallet address no one (including them) has control over, or loses access (i.e. the private key) to the wallet that holds the token. This is a serious issue, as it could stop a Cryptograph from behind transacted and consequently it would not raise money for charity and lose its purpose. If ever a Cryptograph owner permanently loses access to the digital wallet containing the token, the community will be able to reset the Cryptograph after enough time has passed if the owner cannot claim his/her ownership.

### 5. Evolution & Governance

One of the biggest quirks of smart contracts is that once they are published, they become part of the blockchain and thus cannot be modified or deleted. This is a double-edge sword, and the current consensus among the smart contract developer community is that such software should be able to evolve with time, if only to patch unforeseen vulnerabilities.

As such, we are making our contract upgradable with a community consensus mechanism. Cryptograph owners can vote to accept or not accept additions to the smart contract code, but only Perpetual Altruism is able to propose new code. In order to mitigate against voter apathy, if no votes are cast within the reasonable time frame set, then the new code is accepted anyway.

In order to be able to prevent any newly discovered bugs from being maliciously exploited, Perpetual Altruism is also able to instantly freeze all activity in the smart contract. This would allow us to immediately find and solve the bug and then push this new code to the smart contract via the community voting process outlined above.

### 6. Collectibles Powered by Cryptograph

We allow and encourage anyone to create new collectibles using our Cryptograph smart contract. Collectibles created using the Cryptograph smart contract will follow the same set of rules as original Cryptographs (including the auction and trading systems) and will benefit from using a working and trusted platform without the need to develop, audit and publish a new smart contract.

We know communities don't grow by themselves around a product. To have a strong and creative community, you need passionate people with an incentive and an easy way to build and express themselves on top of your product. Therefore, creators of these Cryptograph-powered collectibles will receive all proceeds from the Cryptograph after we take our share, and we do not force these Cryptograph-powered collectibles to give to charity. Their creators are free to choose the charity's share of their collectible and they will handle all donations themselves, however we do encourage them to use their collectible to create a social impact! We will also provide templates for members of the community to create their own webpage for trading their newly minted collectibles. Furthermore, due to the fact Cryptographs exist on a decentralized blockchain, anyone is also free to create their own marketplace that links to our smart contract.

### III. COLLECTIBLE PRICING AND TRADING SYSTEMS

### 1. Pricing Collectibles

Pricing any collectible is a complex exercise. Fungible (i.e. mutually interchangeable) goods like commodities are easily tradable on exchanges that determine market prices by efficiently matching supply with demand. Collectibles, however, are one-of-a-kind. There is no market that can efficiently price them. Price discovery mechanisms for collectible items are as old as trade itself, and the most common of these mechanisms by far is the auction. Auctions are price discovery mechanisms that take into account each participant's value of the item in an incentive-compatible way, and sees the participant attributing the highest value to the item winning the auction thereby buying the item. Incentive compatibility is a state in game theory and economics that occurs when the incentives that motivate the actions of individual participants are consistent with following the rules established by the group.

The most widely used auction system for collectibles is the English auction (a.k.a. open ascending price auction). In an English auction, participants bid openly against one another, with each subsequent bid required to be higher than the previous bid. The highest bidder at any given moment is considered to have the standing bid, which can only be displaced by a higher bid from a competing buyer. The auction ends when no participant is willing to bid further within a given time frame, at which point the highest bidder becomes the winner and pays their bid. Most crypto collectible publishers to date have also opted for a traditional English auction when introducing their non-fungible tokens, such as Crypt® Kitties and Decentraland. One of the reasons the English auction is the most widely used price discovery mechanism to sell collectibles is that in an English auction participants bid openly against one another. This matters a great deal because the uniqueness of the item and the lack of transaction history associated with it make the auction an interdependent value auction: bidders' valuations of the collectible are composed of a common collectible value component and a private value component. Therefore, the values attributed to the crypto collectible by participants influence each other, and may notably increase during the auction as bids are placed and the standing bid price increases. However, the English auction has a weakness: participants are only incentivized to continue bidding the minimum required amount to remain the standing bid until the standing bid reaches their value for the item, and then stop bidding. The consequence is that the highest bidder will only ever pay a price slightly higher than the value of the second highest bidder for the collectible (rather than the maximum value the highest bidder may be prepared to pay), as the auction stops when the second highest bidder drops out.

The Vickrey auction (a.k.a second-price sealed bid auction) was introduced as a way to solve the English auction dominant strategy problem. In a Vickrey auction, bidders submit written bids without knowing the bid of the other auction participants. After all bids have been submitted, the highest bidder wins the auction but pays the second-highest bid rather than his or her own bid. Because of this, all auction participants are incentivized to bid their true value, and this strategy dominates other possible strategies (underbidding and overbidding). However, sealed bid auctions also have a weakness. They are not a good price discovery mechanism when participants are unsure of their own valuations, which is the case for most collectibles. Indeed, although it may appear that a Vickrey auction should net a higher price than an English auction because participants bid their true value, it is not the case. The revenue equivalence theorem stipulates that any private value single-item auction which unconditionally gives the item to the highest bidder is going to have the same expected revenue. In our case of an interdependent value auction, research (Algorithmic Game Theory, Vazirani; Nisan; Roughgarden; Tardos, 2007) finds that it is in fact the English auction that generates more revenue than the Vickrey auction, as it lets the bidders learn information from the bids of other players.

Ultimately, the ideal price discovery mechanism for our crypto collectible would be an English auction where the winner pays the true value he or she attributes to the item and taking into account the value attributed by other participants, rather than the value attributed by the second highest bidder. We are now going to design that auction.

### 2. The Gonnaud-Bessire-McDonaugh (GBM) Auction

In order to design such a price discovery mechanism, it is important to first understand how people bid. There are two theoretical behaviors of participants in an auction, each participant's behavior being a mix of these, which can overlap: The collector behavior, where the participant wants to acquire the collectible and keep it, and the speculator behavior, where the participant wants to acquire the collectible to resell it for a profit. Collectors want to buy the collectible for as low a price as possible, and are not willing to go over their valuation of the collectible, although this valuation can change during an open auction. Speculators want to buy the collectible for as low a price as possible as long as they believe someone else will buy it from them for more. Therefore, theoretically, speculators can profit from placing a bid for an item during the auction as long as there is another bidder that will value the collectible more.

We introduce here the concept of an incentivised auction, which allows speculators to profit within an open auction by pushing collectors to bid their true value. Such an incentivised auction financially rewards participants for placing a bid if that bid is then displaced by a higher bid during the auction. That reward, called the incentive, is taken from the next bidder and ultimately comes out of the winning when calculating the auction revenue. Therefore, in an incentivised auction, bidders that are outbid (i.e. all except the highest bidder, who wins the item) earn incentives.

Let's look at bidding scenarios to better understand how the incentive mechanism impacts the behaviour of collectors and speculators.
One collector and one speculator: the collector will keep outbidding the speculator until the standing bid reaches the collector's value for the item. Hence, the speculator will keep outbidding the collector as long as the speculator believes the collector's value for the item has not been reached.
Many collectors and one speculator: the same strategy is followed by collectors who will keep outbidding each other and the speculator as long as the collectors' highest value for the item is not reached. As Collectors also outbid each other for the item, it is in the interest of the speculator to bid as fast as possible in between each collector's bid so as to maximise the number of incentives earned.
Many collectors and many speculators: the speculators will race each other to be the first to outbid in order to maximise incentives. Because they have no guarantee at all to be able to place any bid, they should maximize the amount they earn per bid. Hence, speculators are incentivized to place a unique bid they think is just under a collector's true value.

However, as the cumulative incentives for the bidders reduce the seller's revenue, it is important to cap this loss in order for an incentivised auction to be attractive to a seller. Hence, we introduce a minimum step a bidder must add to the previous bid to become the standing bid, and this amount must be higher than previous bidder's incentive. Indeed if the minimum step is equal to the previous bidder's incentive, then the totality of the winning minus the first bid could have been paid out to bidders. Hence, the minimum step should guarantee a distribution ratio toward the seller e.g. each bid must be 10% higher than the standing bid with the payout ratio being 2%, thus the seller will receive a minimum 80% of the winning bid as revenue.

The seller (and auction house) wants to minimise incentives whilst keeping the final price as high as possible. To that end, incentives must encourage participants to reach the final price in as few bids as possible. A solution is to ensure that incentives grow in a faster-than-proportional fashion as the participant bids higher relative to the standing bid.

However, an incentive percentage growth is not without its inconveniences either: to guarantee a minimum amount of money going toward the seller, the minimum step needs to grow proportionally to the incentive of the previous bids. Simply, if a participant bids much higher than the previous standing bid, his or her incentive will be larger, and thus the minimum step to displace that new bid must also be higher so as to ensure the seller benefits. This could create an unfortunate situation where bidders would increase significantly the standing bid to an amount very close but still under the “fair” value of the item, yet the next standing bid would have to be disproportionately larger than the “fair” value of the item because of the necessarily high minimum bid. To mitigate this, we suggest the minimum step should be a fixed percentage of the standing bid and a maximum incentive payout should also be set so that it is lower or equal to the minimum step.

### The Gonnaud-Bessire-Mcdonaugh (GBM) Auction

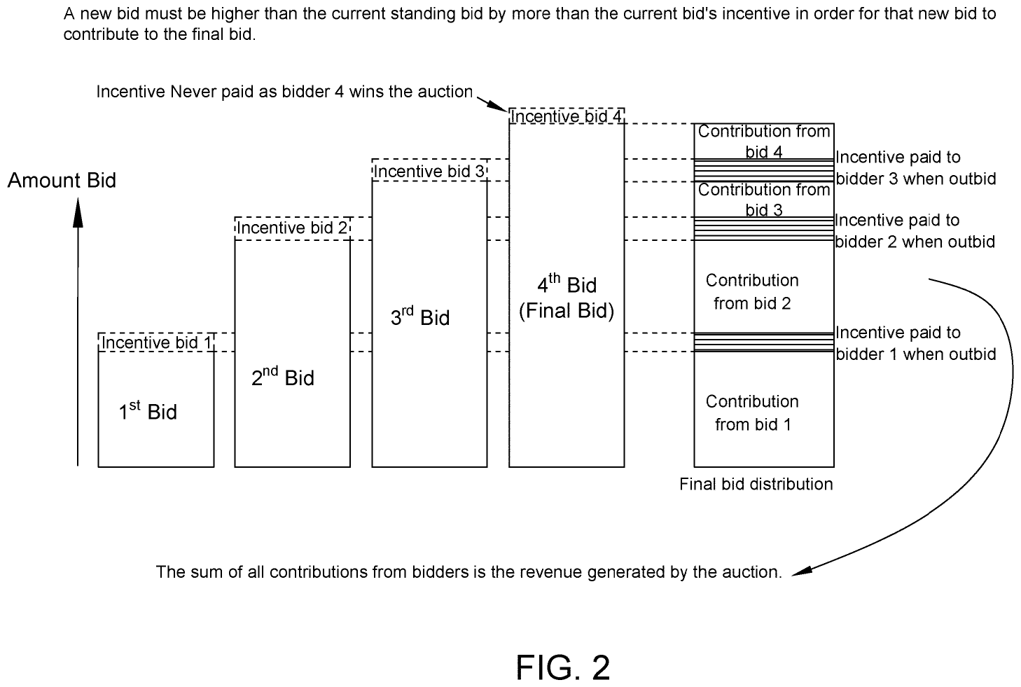

A Gonnaud-Bessire-McDonaugh (GBM) auction is a time-limited incentivised open ascending auction. From a starting price, participants bid openly against one another. The highest bidder at any given moment is considered to have the standing bid, which can only be displaced by a higher bid. Each new bid is required to be higher than the standing bid by a minimum amount. If this new bid is subsequently displaced (by an even higher bid), then the bidder receives an incentive. This incentive is calculated based on the increase that bid represented compared to the previous standing bid. Effectively, the bidder is rewarded for having placed a bid that was later displaced. The auction runs for a set time, and whoever has the standing bid at the end of the auction wins the item and pays their bid. The seller receives the amount of the final bid, minus the sum of the returns that were distributed to bidders. An example of bids in a GBM auction is shown in FIG. 2.

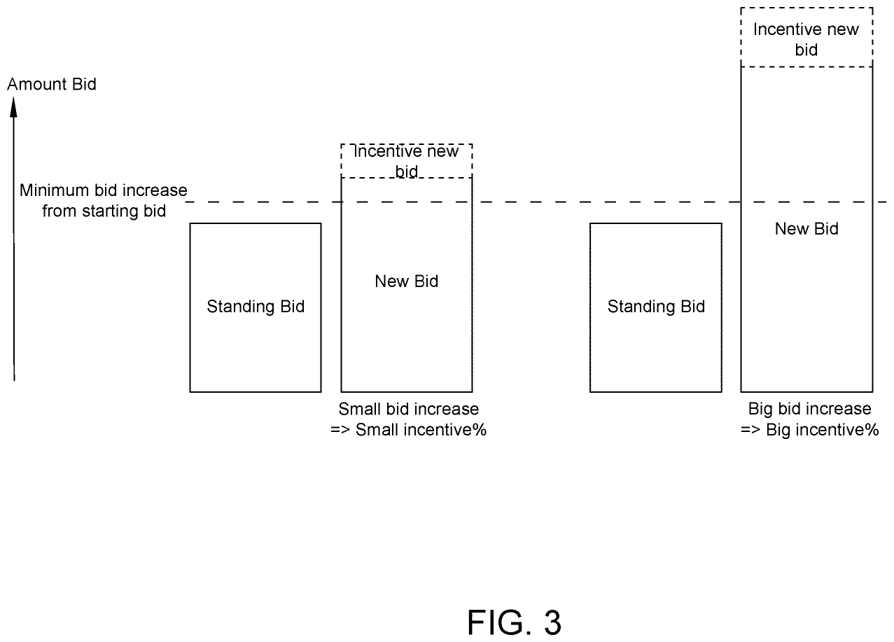

From a bidder's user experience perspective, a GBM auction is exactly the same as a traditional English auction, but with a twist: there is now a minimum step, expressed as a percentage of the current standing bid, which dictates the minimum bid required to become the new standing bid, and participants have advanced knowledge of their incentive gain if someone outbids their standing bid. Two examples are shown in FIG. 3. In the example on the left hand side of FIG. 3, the new bid has a small bid increase, which implies a small bid incentive percentage. In the example on the right hand side of FIG. 3, the new bid has a large bid increase, which implies a large bid incentive percentage.

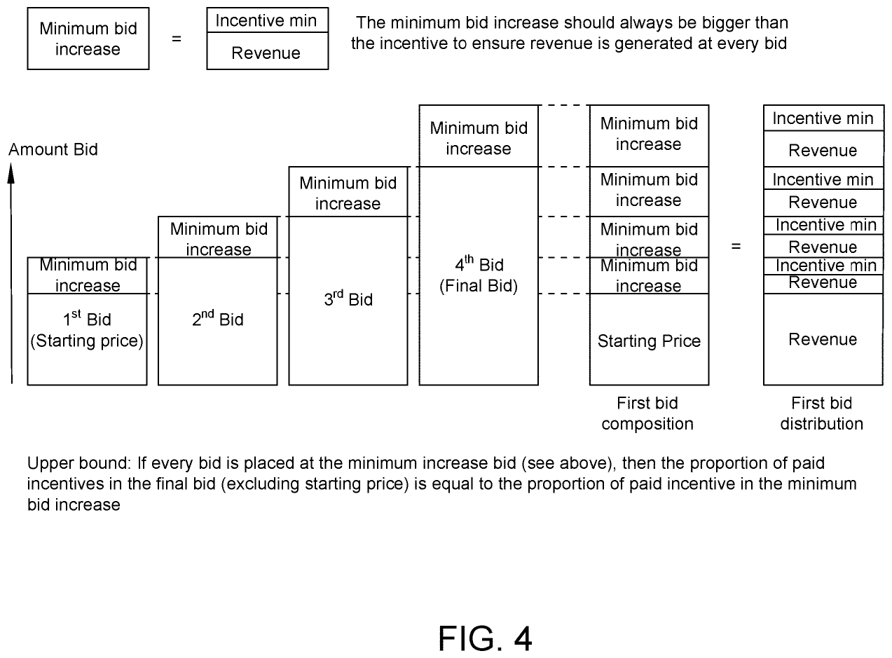

In terms of revenue, the proportion of the winning bid paid to participants as an incentive has an upper and a lower bound. When the final bid is the first bid, no incentive is paid, hence the lower bound is 0%. The upper bound of incentives paid as a percentage of the final bid is reached when each and every bid placed in the auction is strictly at the required minimum bid increase. In that scenario, the maximum number of incentives have been paid out, and the upper bound percentage is equal to the proportion of the minimum incentive relative to the minimal step (see FIG. 4, for example).

For a standing bid s and a new bid n, in an example the new bidder's incentive is calculated using the following formula:

$$incentive ( n , s ) = min [ {inc}_{max} , {inc}_{min} + m \times \frac{n - s \times ( 1 + {step}_{min} )}{s \times ( 1 + {step}_{min} )} ]$$

where stepmin is the minimum bid increment, expressed as a percentage of the current standing bid, incmin is the minimum incentive, expressed as a percentage, incmax is the maximum incentive, expressed as a percentage, m is the mitigating factor, expressed as a positive real number: m controls the growth of the incentive relative to the bids ratio.

### Thoughts and Limitations

The total money flowing in a GBM auction is the sum of all bids, and the total money flowing out to the bidders is the sum of all bids except the highest bid, plus the sum of all incentives paid. Therefore the revenue of a GBM auction is equal to the final price (i.e. the winning bid) minus the aggregated incentives.
The fact that an incentivised auction appears to distribute incentives to bidders using money from new bidders might lead some people to draw comparisons with a Ponzi scheme. However, an incentivised auction is nothing like a Ponzi scheme, and the money used for incentives does not mathematically come from new bidders, but are rather cuts from the final bid. The GBM auction is a transparent process, which does not promise returns but guarantees them, and it does not limit withdrawal of incentives.
Due to the minimum step between each bid, if an item of clearly defined and known commercial value is sold through a GBM auction, it will theoretically generate less revenue than a traditional English auction. That is because bidders would then be incentivised to bid immediately just under the item's known value. By doing so, they would make it so that the next bid would have to be above the known commercial value and enjoy a discount equal to the minimum step.
To our knowledge, the concept of an incentivised auction has not been introduced previously. We believe the main reason for this is that calculating bid incentives in real-time is complex for a human, therefore an incentivised auction would not have been practically possible before computers. Furthermore, the English auction has been a more than adequate price discovery mechanism for collectibles for centuries, with the main auction houses profiting largely and having no real need to improve it.
In a private value English auction the dominant strategy is to bid until the standing bid reaches your value for the item. In a GBM auction, the dominant strategy is an equilibrium of bidding until the standing bid reaches your value and bidding until the expected utility of the incentive from your bid is positive. This is because in an incentivised auction, the outcome function (i.e. the definition of winning) is different. It does not simply mean getting to buy the item, but it also considers profits from the speculation on its value during the auction.
Looking at auction theory, a GBM auction has some rather unique characteristics. Unlike most auctions where participants are risk-neutral, or even risk-averse, participants of a GBM auction are risk-taking, as they are rewarded for placing bids to help in the price discovery. It can also be argued that the auction doesn't follow the Revelation Principle, which states that each of the basic auction types is structured such that each bidder has an incentive to report their valuation honestly. This of course depends on what the definition of valuation is for a speculator, but in the case of a GBM auction one benefits from reporting another bidder's valuation honestly. In that regard, the GBM auction doesn't meet the assumptions of the benchmark model for auctions as defined by McAfee and McMillan (1987) (R. Preston McAfee and John McMillan, Journal of Economic Literature Vol. 25, No. 2 (June, 1987), pp. 699-738). All of this makes a GBM auction a truly innovative price discovery mechanism in our opinion, going beyond what is described in the established auction theory literature.

### 3. Trading Collectibles

How should pricing and trading be handled in the secondary market for collectibles? Without third parties involved in the transaction (only the buyer and the seller have interest), the seller just tries to find whoever is ready to pay the most for the item. But this question is especially interesting when there is a third party involved, such as an auction house, or a publisher in the case of a digital collectible. In that case, the seller may want to circumvent the third party. In the case of a publisher setting trading rules and fees, the biggest threat is black market deals.

One such mechanism is of course the auction, commonly used for collectibles throughout their lifetime, including crypto collectibles (e.g. Crypt® Kitties). Auctions are efficient pricing mechanisms, as discussed, and also largely prevent black market deals. Indeed, assuming an auction cannot be private or invite-only, collectors and speculators alike will be on the lookout for when the collectible goes to auction and they may participate. As the highest bidder wins the item, the seller cannot pick the winner and the best move for the seller and the publisher alike (because of the cut) is then to publicise the auction to as many potential buyers as possible to reach the highest price. However, the limitation of the auction is that the item must be sold once the market price is reached, whatever that price is. Hence a seller may be incentivised to put a high reserve price, which could turn the auction into a sort of sale offer. Requiring the collectible's owner to call for an auction to sell it is not always practical and means the collectible cannot be sold instantly.

Another mechanism, more practical and immediate, is to let buyers place and retract bids and to let sellers accept them at any time. This encourages transactions, as the seller continuously receives bids and buyers may see their bid accepted instantly and at any time. Unfortunately, this mechanism is vulnerable to black market deals e.g. a buyer places a low bid but with a larger secret cash offer by contacting the seller directly, and the seller accepts so as to avoid most of the publisher's cut. There are ways to mitigate that risk. The first is to force the seller to only accept the highest bid, at any time. Then, assuming you let the collector place and retract bids, there needs to be at least one standing aptly priced offer so that black market deals can be avoided. This is where the challenge rests for the publisher, as they may take a proportional cut on the transaction.

In order to prevent black-market activity in an incentive-neutral way, each collectible must be able to receive bids from collectors, and the owner of the collectible must only be able to accept the current highest bid at any time. Such a system makes sure that, as long as at least two independent collectors want the collectible, the owner will have to sell it for a fair value, thus paying a fair cut to the publisher. This system can in theory prevent black market deals, so long as there is always a standing bid for the collectible. We are now going to introduce a version of that system which incentivises buyers to place bids.

### 4. The GBM Perpetual Bidding System

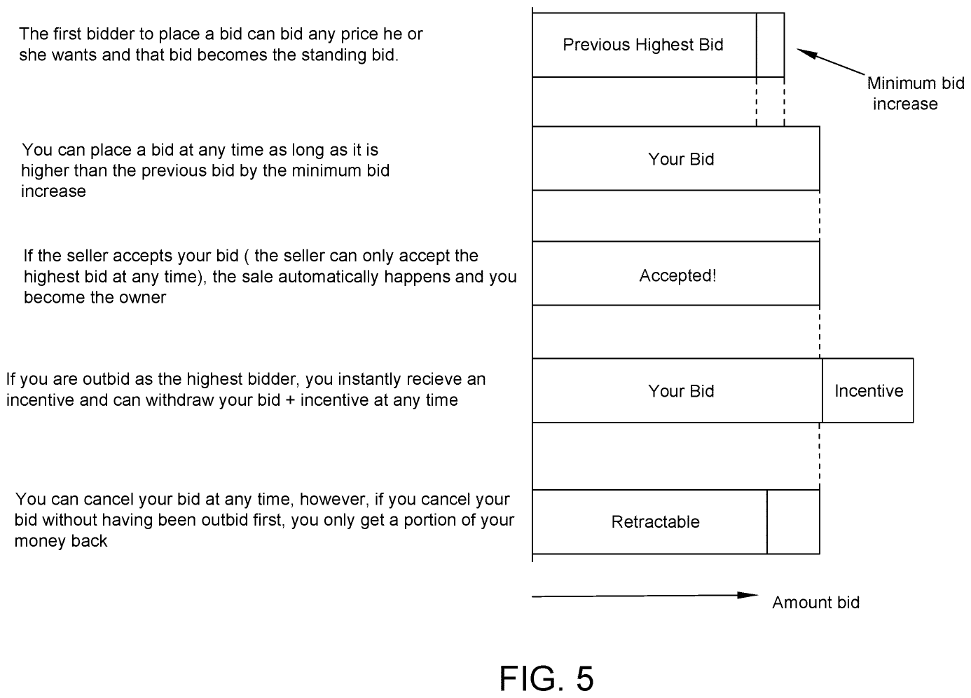

To solve all the aforementioned issues, we introduce a perpetual incentivised bidding system for any subsequent trading of a collectible after its initial auction. This pricing mechanism combines the open ascending element of an English auction, the freedom for buyers to place and retract bids and for sellers to accept them at any time, and a new incentivisation structure to encourage price discovery and stimulate bids, thus preventing black market deals. The perpetual incentivised bidding system works as follows: The first bidder to place a bid on the collectible can bid any price he or she wants and that bid becomes the standing bid. If a standing bid is already present, each new bid is required to be higher than the standing bid by a minimum amount to become the new standing bid. When a new standing bid is placed, an incentive is calculated and the calculation result is supplied to the bidder for that bid, based on the increase the new bid represents compared to the previous standing bid. If this new bid is subsequently displaced (by an even higher bid) then the bidder receives that incentive, effectively rewarding the bidder for having placed a bid that was later displaced. Any bidder is free to retract their bid at any time. However, the current highest bidder can only recover part of his or her bid, as previous incentives have been paid and their bid hasn't been displaced. This also means that the first bidder can always withdraw his or her bid for free, as no incentive has been distributed. If you have been outbid at least once, then you can retract the full amount of your bid, plus an incentive, i.e. you keep the incentive payment you received. At any moment the seller can accept the current standing bid and sell the collectible. When that happens, the publisher takes a cut and then the second highest bid becomes the new standing bid, continuing the bidding. FIG. 5 shows examples of bids in a GBM perpetual bidding system.

The bidder incentive formula may be the same as for the GBM auction, apart from an additional incentive for the first bidder in the perpetual bidding system, who gets the maximum incentive incmax % of the amount of the bid, whatever that amount is. Unlike the auction which may run for a set time, the ability to retract a bid in the perpetual incentivised bidding mechanism ensures that there is no risk for bidders to see their capital immobilised permanently. Furthermore, there are two reasons the current highest bidder cannot recover the full amount of the bid when he or she retracts. First, it ensures genuine bids are placed, as speculators could abuse the system if it cost nothing to do so. Second, the full amount is not available to be recovered, as part of it was used for the incentive of the previous standing bid's bidder. A perpetual incentivised bidding system for each collectible, combined with a cut on each transaction, incentivises the publisher of those collectibles to ensure the biggest possible volume of transactions in a collectible's lifetime. In addition to the cut on each transaction, thanks to the incentive mechanism, an additional cut can also be added on each bid to generate extra revenue for the publisher, hence incentivising them to provide further long term value for the collectible regardless of whether they are transacted or not.

### 5. Blockchain Implementation

A GBM auction and the perpetual incentivised bidding system could be implemented in a closed computer ecosystem. However, being inherently resistant to data modification and secure by design, the blockchain allows for trustless and transparent auctions and trading, hence making it a better candidate. Thanks to smart contract technology, there is no way for the seller or auction house to leave with outstanding bids money as the smart contract only allows past bidders to withdraw their own money (plus incentive) and makes sure the system is completely impartial. In addition, smart contracts support automation of trading and auction rules enforcement. Still, all bids must be fully funded in order to make that automation possible. That is because one can trust their money to be held by a smart contract, whereas a smart contract cannot trust a bidder's promise to pay to be realised. The benefits of this arrangement include guaranteed liquidity on incentive payments, and bidders being able to withdraw their money from the smart contract as soon as they are outbid. English auctions have been successfully implemented (e.g. Crypt® Kitties, AuctionHouse and Auctionity DApps) and performed multiple times on blockchains. The main difference between an English auction and a GBM auction in its implementation is the calculation of incentives and the amounts that can be withdrawn by the participants depending on their situation.

However, the blockchain for all its benefits does raise a few issues that need to be resolved. By design, the incentivised mechanism allows anyone who has power over the order of bids—i.e. the blockchain's miners-theoretically to take advantage of the system. Indeed, a miner could insert its own bid in-between the current bid and an incoming higher bid, therefore being paid an incentive instantly and without committing any capital nor taking any risk. To solve this issue, each new submitted bid must include a reference to the value of the current standing bid at the moment the new bid is submitted.

Another issue raised by a blockchain implementation is the high volatility of the cryptocurrency used in the bidding and trading of the collectibles. Such volatility is to be considered over a several hour auction, but most seriously in the case of the perpetual incentivised bidding system. Luckily, both mechanisms are resilient to cryptocurrency volatility. If the cryptocurrency appreciates, bidding slows down or even halts in the auction, and in the perpetual bidding the current highest bidder might even choose to retract his or her bid if the cryptocurrency has appreciated enough so that it will still be profitable (because of the retraction fee). Alternatively, the seller will be looking at accepting the sale if the appreciation brings the current highest bid to his/her selling value of the collectible. If the cryptocurrency depreciates, new bids will be rapidly placed in both the auction and perpetual bidding in order to maintain the bidding level. This will be encouraged by the speculators who will see the opportunity to insert bids and profit from the price recalibration.

### IV. TECHNOLOGICAL CHOICES & IMPLEMENTATION

### 1. Updatable Smart Contract

The Cryptograph smart contract is implemented following a proxy pattern to allow for updates. In an example, the basic idea is using a proxy for upgrades. The first contract is a simple wrapper or “proxy” which users interact with directly and is in charge of forwarding transactions to and from the second contract, which contains the logic. The key concept to understand is that the logic contract can be replaced while the proxy, or the access point is never changed. Both contracts are still immutable in the sense that their code cannot be changed, but the logic contract can simply be swapped by another contract. The wrapper can thus point to a different logic implementation and in doing so, the software is “upgraded”.

The proxy pattern allows for an evolution of functional code while maintaining the same smart contract address and memory mapping. While new versions of the binaries are submitted by us, they are subject to a vote from the community of Cryptograph token owners directly on the blockchain. This way, the community has the power to accept or reject updates, hence having a direct say in the features and their implementation.

On top of this, at any time the functional (logic) code can be redirected by us to an “empty” smart contract which blocks all money and token transfers. This allows us to freeze the smart contract in case a bug is discovered, giving us time to work on a bug-free version that will be accepted by the community.

### 2. Perpetuity of a Cryptograph

### Renatus

A timer records how much time elapsed since the last interaction of a Cryptograph owner with the smart contract for each token. The timer is reset for that Cryptograph every time the token changes hand, but the owner also has the possibility to call the claim( ) function (for a small gas amount comparable to the cost of a standard money transfer) to do so.

If the owner of a Cryptograph has not interacted at all with the smart contract for over 5 years (for example), anyone becomes then able to reset the Cryptograph by calling the “renatus( )” function (“reborn” in Latin).

When the renatus function is called, a one week (for example) countdown starts during which the owner can still recover the Cryptograph by interacting with the smart contract. If at the end of the one week period (for example) the Cryptograph owner has not recovered it, a second call of renatus by any wallet will irreversibly reset the Cryptograph. The Cryptograph will automatically be auctioned, e.g. in the same fashion as when it was initially published, with the previous highest bid serving as starting bid.

This process ensures that no one directly benefits from the reset of a Cryptograph. The ownership is simply reset, and given away to the winner of the new auction.

In an example, the Renatus function relates to the owner (token holder) proving that he or she still has access to the token i.e. still has the ability to sell the digital item if they wish. If over X years pass, without any transactions, and the current owner has not let the system know (e.g. by calling a function on the smart contract) that he or she still has access to the token (which is in their digital wallet), then the system can put the item up for sale.

### Centimani

Akin to the renatus( ) function, in an example, the publisher has to claim ownership of the Cryptograph smart contract at least once every 2 years in order to reset a timer.

If the publisher fails to do so, any Cryptograph owner will become able to call a centimani( ) function on the smart contract. Once Centimani has been called, the token holders will be able to push code themselves to update the smart contract and vote on it, allowing them to rewrite the way the money flows or how the token behaves. The Cryptograph smart contract will hence become fully controlled by the community of Cryptograph owners, and each owner could be able to set new addresses for their Cryptograph's beneficiaries.

In an example, the Centimani function is about the publisher (i.e. the company that issued the digital item/token, for example our company, Perpetual Altruism) proving that they still have access to the smart contract e.g. can withdraw the generated revenues and push updates to the smart contract etc. If over X years pass without any money withdrawal, update push or another function calls in the smart contract (coming from the company digital wallet), then the smart contract will automatically update its own rules. Our implementation is that each owner (current token holder at the time) will be transferred the publisher rights for the digital item they currently own. If 100 digital items have been issued and are each owned by a different collector when this happens, then these 100 collectors will each become responsible for their digital item. Even after they sell it, they will still be the ones with the publisher rights/powers and will be receiving the proceeds from transaction fees.

In an example, the timer is actually run by the blockchain itself. Instead of being based on a clock running on a server, the timer is based on a number of blocks processed by the blockchain (e.g. “the time limit is reached in 10 blocks, approximately 2 mins”).

In examples, the Renatus and Centimani functions have similarities. They run a timer, and if a certain action (e.g. calling a function on a smart contract) by a certain party (e.g. a token owner or a smart contract publisher) does not happen within a time limit, then modification/updates to the system (e.g. smart contract) are made or can be made by a third party.

### 3. Media on P2P

Blockchains do not provide the ability to create a fully integrated software environment yet. They are merely a backbone to be built upon. This is critical for our use case, because the media is as much an intrinsic part of a Cryptograph than the token itself. In order to guarantee the perpetuity of the media associated with a Cryptograph token, the media is stored in several redundant ways.

A hash of the media as well as a link to download it (e.g. either a bittorrent magnet or an InterPlanetary File System (IPFS) address (InterPlanetary File System (IPFS) is a protocol and network designed to create a content-addressable, peer-to-peer method of storing and sharing hypermedia in a distributed file system)) are stored directly on the blockchain. Moreover, said media is also being stored on our server, to not only guarantee at least a seed for the P2P download, but also to provide adequate streaming capacities for the App owners.

Ideally, the media itself would be stored along the token on the smart contract, but this is currently technically not possible on the blockchain. Thanks to our smart contract being upgradable, this feature could be implemented if storing media on the blockchain becomes possible and practical eventually.

### 4. Why the Ethereum Blockchain

The nature of the Cryptograph project requires a blockchain with an extensive smart contract system. This system needs to allow for the implementations of all our desired features, such as having low transaction fees. Moreover, this blockchain needs to have a cryptocurrency that has a big enough market capitalization that allows for the auctions to happen without impacting the value of the currency itself. We thus chose to develop using the Ethereum blockchain based on its popularity, its simple and powerful contract language and toolchain/user interface (UI), as well as the attractive transaction latency and fees.

### 5. Collectibles Powered by Cryptograph

In order to foster the creation of a collectible on top of the Cryptograph smart contract, we provide the community with:
A wizard for Cryptograph Creation with a web3 (the Decentralized Web) interface to publish a Cryptograph for only a few cents worth of gas, instead of the hundreds of pounds that publishing a full smart contract would require
HTML/Web3 templates to integrate their created collectibles into their personal websites/app and advertise them.

Of course, more motivated creators could go further, for examples creating alternative auction sites for these community Cryptographs or to display analytics on these tokens.

In order to increase the appeal of the Cryptograph concept to creators, community-created Cryptographs do not have to abide by the rule that states that the majority of proceeds must go to charitable causes. Creators are free to choose the charity share of their collectible and will handle donations themselves, although we encourage them to use their collectible to create a social impact! We will endeavour to find great communities powered by Cryptograph collectibles that are raising money for social good and will feature them on our marketplace.

### 6. Stateless Marketplace

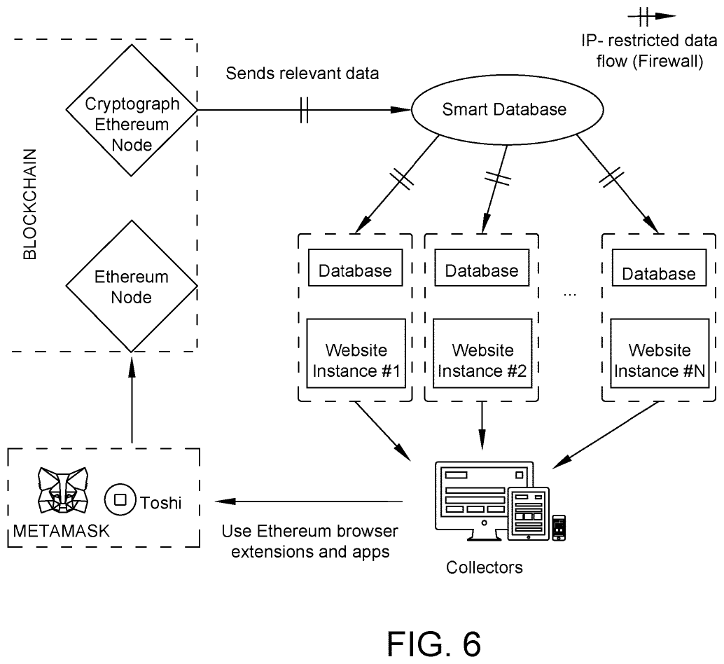

We have a smart database which is connected to the Ethereum blockchain through an Ethereum node. This smart database collects information from the blockchain that is relevant to the Cryptograph smart contracts, and implements a Data application programming interface (API) only callable by our own application servers: Those are either website servers or mobile app servers. Our application servers maintain their own database, each of which is regularly updated by calling the smart database. The servers for the websites are themselves exposed to the web. Should one of those fail/be hacked, it would not impact other servers nor would it impact the smart database, as servers are independent from each other and can only read from the smart database. Our website servers are essentially interfaces allowing users to read and interact with the blockchain, as shown for example in FIG. 6. To interact with the blockchain, collectors will have to use Ethereum browser extensions and apps whilst browsing our website, which will connect to the blockchain through their own Ethereum nodes. An example stateless marketplace is shown in FIG. 6.

### V. CONCLUSION

Blockchain technology has unveiled new opportunities for digital collectibles. For the first time in history, something digital can be scarce in an open software environment and without the reliance on a central authority. This technology ensures the scarcity, provenance and perpetuity of a digital collectible and allows its publisher to implement transaction rules in a secure and transparent environment. We believe that crypto collectibles will be one of the first widely adopted consumer applications of blockchain technology.

A Cryptograph is an entirely new form of digital collectible that brings fans closer to the individuals that they so admire and allows famous individuals to create an everlasting charitable legacy for causes that they care about, whilst at the same time maintaining control over their fame and how it is used. The perpetuity of Cryptographs is ensured even in the cases of a digital wallet loss or the extinction of our company. On top of these intrinsic value points, Cryptographs are supported by a sustainable social enterprise business model that aligns the interests of the publishers, creators and the collectors to do good. Furthermore, the community has the ability to use our work to build new collectibles on top of the Cryptograph smart contract.

The GBM auction and perpetual bidding system are innovative price discovery mechanisms stimulating long term value and discouraging black market deals. There is a lot more to be discussed on the concept of the incentivised auction and perpetual bidding system, but we believe that they could become new standards for collectibles. However it is our opinion that these models can still be improved upon, both from a theoretical and a blockchain implementation perspective.

### Glossary

Auction house

A company that runs auctions and which takes a cut of the final sales price as a business model.

### Bid

A particular amount of money offered for an item made by a potential buyer, whether at an auction or not.

### Blockchain

A digital ledger in which transactions (e.g. in cryptocurrencies) are recorded chronologically and publicly.

### Ethereum

A blockchain which uses the Ether cryptocurrency (ETH) and that can run software within it called smart contracts.

### Hash

A string of fixed size created by a mathematical mapping algorithm designed as a one-way function (e.g. a function which is infeasible to invert).

### Non-Fungible

Describes a good or asset that is not fungible i.e. that can't be interchanged with other individual goods or assets of the same type. For example: unique precious stones and collectibles are non-fungible, whilst currencies are fungible.

### Offer

A particular amount of money demanded for the sale of an item, made by a potential seller.

### Publisher

A company or person that creates and issues collectibles, e.g. under a distribution licence.

Social enterprise

An organization which applies commercial strategies to try and maximize social impact alongside creating value for its shareholders.

Smart contract

A unique piece of software that runs within a blockchain.

### Token

A digital proof of ownership whose behavior is regulated by a smart contract in the blockchain.

### Self-Upgradable Smart Contracts

The “Version Controller” architecture

### Extract

One of the main features of smart contracts is the immutability of their code: once a smart contract is published on to the blockchain ledger, even its publisher cannot make any amendments to it. This feature is both their greatest strength, which brings complete trust in the smart contracts (e.g. a user can send money to a smart contract and know for sure that the publisher cannot play foul), and their greatest weakness, as a mistake cannot be fixed if discovered after publication. A good example of this weakness is the bug in the decentralized autonomous organization (DAO) which nearly killed the Ethereum blockchain and prompted a hard fork in 2016. After the DAO bug, smart contract developers realised that going forward smart contracts needed to move toward a new paradigm: Upgradable smart contracts. Smart contracts that can have parts of their code replaced and implement specific governance rules to allow these upgrades.

To this end, the proxy pattern emerged and is now widely used by blockchain developers. Sadly, this pattern cannot be directly applied to instanced smart contract through a factory pattern, as they would require their publisher to upgrade each of them manually in separate transactions, creating a possible race between the publisher pushing a bugfix update and bug exploiters exploiting a weakness in a yet unpatched instance. (In class-based programming, the factory method pattern is a creational pattern that uses factory methods to deal with the problem of creating objects without having to specify the exact class of the object that will be created. This is done by creating objects by calling a factory method, either specified in an interface and implemented by child classes, or implemented in a base class and optionally overridden by derived classes, rather than by calling a constructor).

Instead, if every proxied instance were to refer to a single centralized Version Controller smart contract which contains an index of all the up-to-date smart contract logic code addresses, publishers would just have to update the addresses in this version controller to update all of the instanced smart contracts at once. This centralized update process could then itself have a decentralized governance system, making simultaneous but decentralized update of a large amount of complex smart contracts possible. The DAO with a Version Controller mechanism embedded into it would have not led to a fork of the Ethereum blockchain.

### Smart Contracts and Delegate Calls

Smart contracts are pieces of software that are executed on a blockchain, a decentralised ledger technology platform.

A smart contract on the Ethereum blockchain is a combination of its address, bytecode and memory state. To interact with a smart contract, a user asks the address to execute the bytecode matching a (function signature), while the memory state is only ever accessed by the smart contract itself—or a human reading directly into the EVM (Ethereum Virtual Machine, basically a virtual computer in which memory space is the blockchain state) memory.

When a variable is declared as “public” in Solidity (an object-oriented programming language for writing smart contracts), it does not make the memory accessible. Instead, it is implicitly specifying that at compilation, a “view” function with a signature matching the variable name will be created. The difference between public and private variables is in the bytecode, not in the memory state.

The basic smart contract interaction look like this:

User=>call [Original Smart contract address] (function signature) (arguments)

The EVM will look at [Original Smart contract address] for any matching (function signature) bytecode. If none are found, then the fallback function is called instead. If found, then the arguments are loaded into memory and the bytecode found for the matching function is executed. This bytecode is the only bytecode authorized to modify any memory space associated with [Smart contract address].

Of course, a smart contract can execute the functions of another smart contract (i.e. a smart contract can call another smart contract as part of the execution of one of its functions). However, these calls are done with their own call [Different Smart Contract Address] (different function signature) (different arguments), and the function called cannot access nor modify the memory space of the Original Smart Contract.

This matters a lot, because the publication of a smart contract happens in a single transaction on the blockchain. The consequence is that there is a hard limit as to how big a smart contract bytecode can be: the block size. Any smart contract bigger than the block size (e.g. a few kilobytes) is technically impossible to publish on the blockchain. Furthermore, the closest to the block size a smart contract bytecode is, the more expensive it is to publish (e.g. exponentially). This also means that any code that would make modification to the Original Smart contract memory space would need to be smaller than the blocksize.

To circumvent this limitation, another kind of function call was implemented into the EVM: delegateCall.

delegateCall makes the called smart contract access the calling smart contract memory space instead of its own. E.g.:

If Original Smart Contract performs a

delegateCall [Different Smart Contract Address] (function signature) (arguments)
then the bytecode being executed in Different Smart Contract would be referring Original Smart Contract memory space instead of Different Smart Contract memory space.

In essence, delegateCall is allowing Original Smart Contract to execute Different Smart Contract bytecode as if it were its own bytecode. One of the requirements to prevent any kind of bug-type behaviour is that the storage slots of the two smart contracts must align—i.e the same variable types must be declared, in the same order—. This is to make sure the generated bytecode of the Different Smart Contract can access the correct memory offsets of the Original Smart Contract storage.

. . .
note: this whole process went through several iterations in the EVM specs:
call is a traditional call.
callcode allows remote bytecode to touch the caller memory but replace the msg.sender value with the calling smart contract address
delegateCall in its first iteration would allow remote bytecode and would leave msg.sender of a delegatecall as the original user calling the smart contract, but would only return 32 bytes of data maximum
delegateCall in it's latest iteration (Byzantine Hard Fork) allows for arbitrary length of data being returned
. . .

While the initial purpose of callcode/delegateCall was to allow the creation of libraries so that developers could squeeze in more code in their smart contracts, this allowed something even more interesting to emerge: Upgradable smart contracts.

### Upgradable Smart Contracts

Let's take our original scenario. A user is interacting with a smart contract

User=>call [Original Smart contract address] (function signature) (arguments)

Now, let's suppose our Original Smart contract doesn't have any bytecode except for a fallback function that does the following:

delegateCall [Different Smart Contract Address] (function signature) (arguments)

In essence, our Original Smart contract is just a passive memory state that reroutes all incoming requests to Different Smart Contract and then passes on their return values to the user. And while the rerouting bytecode of Original Smart contract can't be changed once published on the blockchain, the bytecode of Different Smart Contract Address is in memory space, and hence can be updated!

This programming pattern of smart contract is called a Proxy Pattern. Although it is not possible to upgrade the code of your already deployed smart contract, it is possible to set-up a proxy contract architecture that will allow you to use new deployed contracts as if your main logic had been upgraded.

A proxy architecture pattern is such that all message calls go through a Proxy contract that will redirect them to the latest deployed contract logic. To upgrade, a new version of your contract is deployed, and the Proxy is updated to reference the new contract address.

. . .

### Implementation Notes:

For a true proxy pattern, the layout of state variables in storage should stay the same BUT the visibility of all its variable members in solidity should be set to internal in the Original Smart contract, to avoid generating getters for them in the bytecode. (Getter functions enable you to read data saved in the blockchain.)

### Layout of State Variables in Storage

Statically-sized variables (everything except mapping and dynamically-sized array types) are laid out contiguously in storage starting from position zero. Multiple, contiguous items that need less than 32 bytes are packed into a single storage slot if possible, according to the following rules:
The first item in a storage slot is stored lower-order aligned.
Elementary types use only as many bytes as are necessary to store them.
If an elementary type does not fit the remaining part of a storage slot, it is moved to the next storage slot.
Structs and array data always start a new slot and occupy whole slots (but items inside a struct or array are packed tightly according to these rules).

For contracts that use inheritance, the ordering of state variables is determined by the C3-linearized order of contracts starting with the most base-ward contract. If allowed by the above rules, state variables from different contracts do share the same storage slot.

In computing, the C3 superclass linearization is an algorithm used primarily to obtain the order in which methods should be inherited (the “linearization”) in the presence of multiple inheritance, and is often termed Method Resolution Order (MRO).

### C3 Linearization Results in Three Important Properties:

a consistent extended precedence graph,
preservation of local precedence order, and
fitting the monotonicity criterion.

The elements of structs and arrays are stored after each other, just as if they were given explicitly.

. . .

Proxy contracts open up the possibility of upgrading smart contracts, but this upgrade still needs to be triggered by an interaction from the “owner” of the proxy: The Business

Logic Code Smart Contract Address needs to be changed in the Proxied Smart contract storage memory.

While for traditional, single contract development this is not an issue, this is more problematic when using patterns such as a factory pattern: How to ensure that all of the many instantiated smart contracts are upgraded simultaneously, and with as little transactions as possible? (If possible a single transaction from the publisher).

Let's Introduce a Version Controller smart contract. This contract core is fairly simple: It simply is a public array of addresses. Now, instead of remembering the address of the Business Logic Code Smart Contract, the Proxied Smart Contract will remember the Version Controller Smart Contract Address as well as a Version Index. When getting called, the Proxied Smart Contract instead executes the following:

User=>call [Proxied Smart Contract] (function signature) (arguments)

This part stays unchanged. Apart from gas consideration, the user experience (UX) is unchanged for the user. However, the fallback function of the Proxied Smart Contract is now doing the following:

delegateCall [call Version Controller (giveMeMyBuisnessCallAddress) (Version Index)] (function signature) (arguments)

The proxied smart contract doesn't even know his own business code address anymore. Instead, he asks the Version Controller (VC) to provide it so that the user task can be forwarded to it.

. . .

### Note:

The Version Controller can be a proxy upon itself, simply replacing the call to the version controller address to a simple internal memory lookup in its fallback function.

. . .

The update process will now require the smart contracts publisher to simply change the content of the Version Controller Storage Array at the index (Version Index) instead of having to manually change the address of every instanced smart contract that needs to be updated.

Moreover, if the updating process requires an initialization step, an intermediary update smart contract can be used. Simply insert the new version of the business logic code in the Version Controller Storage Array, and set the address at the previous Version Index to be the intermediary update smart contract address.

Its code would look like (in pseudocode, as Solidity still requires complex manipulation of the EVM for delegateCall):

contract logicCodeV1ToV2 is storageStructureInternal {

//fallback function that is always gonna be executed

function ( ) external payable {

//Here do memory stuff related to update that need to be done only once such

as :

Newvariable = 42;
//Set the internal version index to the new version of the code in the array.
Version_Index = 14;

//Pass along the call exactly as if we were the Proxied Smart Contract. And because we
are getting delegateCalled, we are doing this.
delegateCall [call Version_Controller (giveMeMyBuisnessCallAddress) (Version_Index)]
(function signature) (arguments)

}

}

If the Version Controller storage array's initial state was like :
[...] = [0x....]
[Version Index] = [V1 of Business Logic Code Smart Contract Address]
[...] = [0x....]
Then once setup for self update of all our instanced smart contracts, it would look like :
[...] = [0x....]
[Version Index] = [ logicCodeV1ToV2 Address]
[...] = [0x....]
[14] = [V2 of Business Logic Code Smart Contract Address]
[...] = [0x....]

This will ensure that any and all calls made to Proxied Smart Contract are always made in the context of the latest version of the business logic code, and that no transaction is ever wasted to update a smart contract that no one is using.

Moreover, it is possible to chain such updates together (gas limit permitting) so that some instances could be left un-updated for years but self-update through all of the successive versions of the business logic code as soon as someone interacts with them.

. . .

### Notes:

If using purely internal storage variables declaration for the logicCodeV1ToV2, then any getter function for them will fail, as the user call was expecting to not trigger any blockchain state change with his transaction but now suddenly the memory starts changing.

Henceforth, developers should put the appropriate views function if they want users to be able to consult results that would not be affected by the update. However, any such view function will not trigger the fallback function of the logicCodeV1ToV2, and hence will not trigger an update either.

. . .

In summary, by using a Centralized Version Controller for proxies, smart contract developers gain a tool that allows them to have factories instance cheaply on complex smart contracts that are guaranteed to always execute the latest version of the code being pushed to the blockchain without needing to micromanage any of them individually.

In fact, your factory could be made public and anyone could instance your factory objects that use your Version Controller and always be guaranteed to use the latest published business logic, basically piggybacking on your research and development.

Having the process upgrade being so cleanly separated from any of the business logic (everything is fully handled in the Version Controller) makes it a great structure to experiment with more decentralized governance, as only one call is enough to update all smart contracts ever published using the business logics vs having to elect a centralized authority that then updates all of them manually or making the update an opt-in from users and instantly creating a fork.

### What is Ethereum Gas? . . .

Ethereum Gas is a factor for estimating the computational performance of running transactions or smart contracts in the Ethereum network. The price is not demanded by wallets or other assistance providers; rather, it is given to miners for mining blocks of activities and for defending the Ethereum blockchain. This price is given by users to miners and is subtracted from their total transaction value.

Ethereum Gas: Gas is a unit that measures the amount of computational effort that it will take to execute certain operations.

Every single operation that takes part in Ethereum, be it a simple transaction, or a smart contract, or even an Initial Coin Offering (ICO) takes some amount of gas. Gas is what is used to calculate the amount of fees that need to be paid to the network in order to execute an operation.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1-24. (canceled)

25. Computer implemented method of auctioning an item for a seller, the method including the steps of:
(i) a server providing a starting price of the item to a plurality of computer terminals in communication with the server, wherein the starting price is a standing bid;
(ii) the server receiving a bid from a terminal of the plurality of terminals;
(iii) the server converting the received bid into a standing bid only if the received bid exceeds the previous standing bid by a threshold;
(iv) if the standing bid has increased, the server providing the standing bid to the plurality of computer terminals;
(v) repeating steps (ii) to (iv) until a condition is satisfied;
(vi) receiving payment for the item in relation to a final standing bid;
(vii) distributing incentive payments in relation to each standing bid, except for the final standing bid, to parties respectively associated with each standing bid;
(viii) distributing payment to the seller, which is the payment received in step (vi), minus at least the sum of the incentive payments in step (vii).

26. The method of claim 25, wherein in step (vi) the server receives the payment for the item in relation to the final standing bid.

27. The method of claim 25, wherein as soon as the standing bid has increased, a respective incentive payment is made.

28. The method of any of claim 25, wherein in step (vii) the server distributes the incentive payments in relation to each standing bid.

29. The method of claim 25, wherein in step (viii) the server distributes the payment to the seller.

30. The method of claim 25, wherein no incentive payment is distributed in relation to the starting price.

31. The method of claim 25, wherein each incentive payment is a portion of an amount by which the respective standing bid exceeded the previous standing bid.

32. The method of claim 31, wherein the portion is a fixed fraction, less than one.

33. The method of claim 25, wherein the condition in step (v) is that a time limit for the total time for the auction is reached.

34. The method of claim 25, wherein the condition in step (v) is that a time limit for no new standing bid occurring is reached.

35. The method of claim 25, wherein the threshold in step (iii) is a fraction less than one, of the current standing bid.

36. The method of claim 25, wherein the item is a digital item.

37. The method of claim 36, wherein the server transmits the digital item to a party associated with the final standing bid.

38. The method of claim 25, wherein the seller can set an asking price that, if met, terminates the auction.

39. The method of claim 25, wherein the server records in a blockchain a transaction in which the item was sold by the seller to a party associated with the final standing bid.

40. The method of claim 39, wherein the server records the transaction in the blockchain as a smart contract.

41. The method of claim 25, wherein the server records in a blockchain each new standing bid.

42. The method of claim 41, wherein the server records each new standing bid in the blockchain as a smart contract.

43. The method of claim 39, wherein the blockchain is an Ethereum blockchain.

44. The method of claim 25, wherein the method is implemented in a closed computer ecosystem.

45. The method of claim 25, wherein each new submitted bid is required to include a reference to the value of the current standing bid at the moment the new bid is submitted.

46. The method of claim 25, wherein the payments are cryptocurrency payments.

47. The method of claim 25, wherein all bids are fully funded.

48. Computer implemented method of auctioning a digital item for a seller, wherein the digital item was previously purchased by the seller in a computer implemented method of auctioning the digital item, the method of this claim including the steps of:
(i) a server receiving a bid for the digital item from a terminal of a plurality of computer terminals in communication with the server, wherein the server uses the bid as the standing bid;
(ii) the server providing the standing bid to the plurality of computer terminals;
(iii) the server receiving a bid from a terminal of the plurality of terminals;
(iv) the server converting the received bid into the standing bid only if the received bid exceeds the previous standing bid by a threshold;
(v) if the standing bid has increased, distributing an incentive payment in relation to the previous standing bid;
(vi) if the standing bid has increased, the server providing the standing bid to the plurality of computer terminals;
(vii) repeating steps (iii) to (vi) until a command is received from the seller to terminate the auction.

49. The method of claim 48, wherein any respective bid may be retracted using a respective terminal of the plurality of terminals at any time before the command is received from the seller to terminate the auction.

50. The method of claim 48, wherein if the current standing bid is withdrawn, a penalty payment must be received.

51. The method of claim 48, wherein if the standing bid has increased, a payment must be received from the bidder for the new standing bid, to provide payment for the incentive payment to the bidder for the previous standing bid.

52. The method of claim 48, wherein if the current standing bid is withdrawn, there is no refund of the incentive payment that was made to the bidder of the previous standing bid.

53. The method of claim 48, wherein after the command is received from the seller to terminate the auction, the digital item is sold from the seller to the holder of the highest standing bid, and a new auction starts, with the previous standing bid becoming the current standing bid.

54. The method of claim 48, wherein after the command is received from the seller to terminate the auction, the digital item is sold from the seller to the holder of the highest standing bid, and the publisher of the digital item receives a commission payment.

55. The method of claim 48, wherein if the standing bid has increased, the publisher of the digital item receives a commission payment.

56. The method of claim 48, wherein all bids are fully funded.

57. The method of claim 48, wherein in step (v) if the standing bid has increased, funding for the bid is received (e.g. by the server).

58. The method of claim 48, wherein after step (viii) the payment is distributed to the seller (e.g. by the server).

59. The method of claim 48, wherein each incentive payment is a portion of an amount by which the respective standing bid exceeded the previous standing bid.

60. The method of claim 59, wherein the portion is a fixed fraction, less than one.

61. The method of claim 48, wherein the threshold in step (iv) is a fraction less than one, of the current standing bid.

62. The method of claim 48, wherein the server transmits the digital item to a party associated with the final standing bid.

63. The method of claim 48, wherein the server records in a blockchain a transaction in which the item was sold by the seller to a party associated with the final standing bid.

64. The method of claim 63, wherein the server records each transaction in the blockchain as a smart contract.

65. The method of claim 48, wherein the server records in a blockchain each standing bid.

66. The method of claim 65, wherein the server records each standing bid in the blockchain as a smart contract.

67. The method of claim 63, wherein the blockchain is an Ethereum blockchain.

68. The method of claim 48, wherein the method is implemented in a closed computer ecosystem.

69. The method of claim 48, wherein each new submitted bid is required to include a reference to the value of the current standing bid at the moment the new bid is submitted.

70. The method of claim 48, wherein the payments are cryptocurrency payments.

71-85. (canceled)
